(19) United States
(12) Patent Application Publication
(10) Pub. No.: US 2023/0196769 A1
(43) Pub. Date: Jun. 22, 2023

(54) POSTING SUPPORT APPARATUS, AND POSTING SUPPORT METHOD

(71) Applicant: Cookpad Inc., Kanagawa (JP)

(72) Inventors: Christopher TROTT, Kanagawa (JP); Leszek Piotr RYBICKI, Kanagawa (JP)

(73) Assignee: Cookpad Inc., Kanagawa (JP)

(21) Appl. No.: 18/113,086

(22) Filed: Feb. 23, 2023

Related U.S. Application Data
(63) Continuation of application No. PCT/JP2021/015781, filed on Apr. 16, 2021.

(30) Foreign Application Priority Data
Aug. 31, 2020 (JP) 2020-145753

(51) Int. Cl. G06V 20/30; G06V 10/94; G06V 10/70; G06Q 50/00

(52) U.S. Cl. CPC G06V 20/30; G06V 10/945; G06V 10/70; G06Q 50/01; G06V 2201/10

(57) ABSTRACT

A posting support apparatus 10 is provided with an image storage section 100 for storing a plurality of image data items, a model storage section 101 storing a trained model 1011 for determining a type of a subject in an image, a classification processing section 102 for inputting each of the image data items to the trained model 1011 to classify each of the image data items as a target image in which a subject of a specified type is captured or a non-target image in which a subject other than the subject of the specified type is captured, and a candidate presentation section 103 for displaying the target image or the non-target image as a user's utilization candidate image.

### CROSS-REFERENCE TO RELATED APPLICATIONS

This application is a Continuation Application of No. PCT/JP2021/015781, filed on Apr. 16, 2021, and the PCT application is based upon and claims the benefit of priority from Japanese Patent Application No. 2020-145753, filed on Aug. 31, 2020, the entire contents of each are incorporated herein by reference.

### FIELD

The present disclosure relates to a posting support apparatus, and a posting support method.

### BACKGROUND

With the evolution of camera functions in smartphones, people have come to easily take pictures of various subjects in various scenes. Especially in recent years, the frequency and opportunities to take pictures have been increasing more and more as part of a life log for oneself or one's family, or for posting on a social networking system (SNS) or a recipe posting site.

For example, Japanese Patent Application Publication No. 2014-89564 discloses a technique of inputting an image photographed by a user as information on a meal consumed by the user for daily dietary management or the like. This technique relates to an information processing apparatus for suppressing processing load by limiting data to be referred to for dish recognition while maintaining the accuracy of dish recognition from an image, the information processing apparatus comprising: an image acquisition unit for acquiring a dish image in which one or more dishes are captured; and a first dish recognition unit for recognizing the one or more dishes included in the dish image by referring to dish data selected from pre-registered dish data based on conditions relating to at least one of a person associated with the dish image, an environment in which the dish image was captured, a place where the dish image was captured, and a time when the dish image was captured.

An enormous number of images are accumulated over time in the user's smartphone as described above. On the other hand, as time passes after image capturing or as the number of captured images increases, the images in the smartphone tend to be forgotten by the user, and the range of effective use of the images by the user tends to be limited.

Therefore, it is difficult for the user to identify an image that matches the purpose of use from a huge group of images in the smartphone, and it may be impossible for the user to reach an appropriate image in the first place. Despite the fact that it is easy to take pictures with a smartphone, technology to search and utilize images obtained thereby has not been sufficiently provided.

Such a situation may lead to a decrease in usability of a service or an application that requires the user to input or post an image, and thereby to a decrease in service satisfaction. Therefore, for service operators and application providers, the above situation is a big problem that cannot be ignored.

### BRIEF DESCRIPTION OF THE DRAWINGS

FIG. 1 is a diagram of an example network configuration including a posting support apparatus of the present embodiment.

FIG. 2 is a diagram showing an example configuration of the posting support apparatus in the present embodiment.

FIG. 3 is a diagram showing an example configuration of a posting site system in the present embodiment.

FIG. 4 is a diagram showing an example configuration of an image DB in the present embodiment.

FIG. 5 is a diagram showing an example configuration of a model DB in the present embodiment.

FIG. 6 is a diagram showing an example flow of a posting support method in the present embodiment.

FIG. 7 is a diagram showing an example flow of the posting support method in the present embodiment.

FIG. 8 is a diagram showing an example screen in the present embodiment.

FIG. 9 is a diagram showing an example screen in the present embodiment.

FIG. 10 is a diagram showing an example screen in the present embodiment.

FIG. 11 is a diagram showing an example screen in the present embodiment.

FIG. 12 is a diagram showing an example screen in the present embodiment.

### DETAILED DESCRIPTION

In order to achieve the above object, a posting support apparatus according to one aspect of the present disclosure is provided with an image storage section for storing a plurality of image data items, a model storage section storing a trained model for determining a type of a subject in an image, a classification processing section for inputting each of the image data items to the trained model to classify each of the image data items as a target image in which a subject of a specified type is captured or a non-target image in which a subject other than the subject of the specified type is captured, and a candidate presentation section for displaying the target image or the non-target image as a user's utilization candidate image.

In a posting support apparatus according to one aspect of the present disclosure, the candidate presentation section may be configured to generate a thumbnail list of the target image or the non-target image and output the thumbnail list.

In a posting support apparatus according to one aspect of the present disclosure, the candidate presentation section may be configured to associate a plurality of the non-target images to one thumbnail, superimpose information indicating a number of the non-target images on the thumbnail, and expand and display thumbnails of the non-target images associated with the thumbnail when receiving a user's operation to select the thumbnail.

In order to achieve the above object, a posting support method according to one aspect of the present disclosure is a method in which an information processing apparatus holds a plurality of image data items and a trained model for determining a type of a subject in an image and executes a process of inputting each of the image data items to the trained model to classify each of the image data items as a target image in which a subject of a specified type is captured or a non-target image in which a subject other than the subject of the specified type is captured and a process of displaying the target image or the non-target image as a user's utilization candidate image.

In a posting support method according to one aspect of the present disclosure, the information processing apparatus may generate a thumbnail list of the target image or the non-target image and output the thumbnail list.

In a posting support method according to one aspect of the present disclosure, the information processing apparatus may associate a plurality of the non-target images to one thumbnail, superimpose information indicating a number of the non-target images on the thumbnail, and expand and display thumbnails of the non-target images associated with the thumbnail when receiving a user's operation to select the thumbnail.

In order to achieve the above object, a posting support program according to one aspect of the present disclosure is a program for causing an information processing apparatus to: hold a plurality of image data items and a trained model for determining a type of a subject in an image; and execute a process of inputting each of the image data items to the trained model to classify each of the image data items as a target image in which a subject of a specified type is captured or a non-target image in which a subject other than the subject of the specified type is captured and a process of displaying the target image or the non-target image as a user's utilization candidate image.

<Network Configuration Including Posting Support Apparatus>

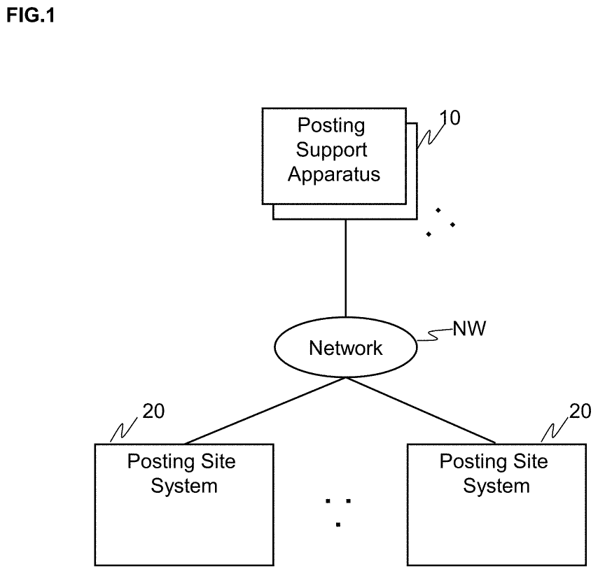

Hereinafter, an embodiment of the present disclosure will be described with reference to the drawings. FIG. 1 is a diagram of an example network configuration including a posting support apparatus 10 and a posting site system 20 of the present embodiment.

The posting support apparatus 10 in the present embodiment is an information processing apparatus of a user who accesses an appropriate posting site operated by the posting site system 20 and posts at least an image. Specific examples of the posting site include, but are not limited to, a recipe posting site that accepts posting of a recipe created by a user and publishes the recipe, a caught fish posting site that accepts posting of caught fish information of a user and publishes the information, and a general social networking service (SNS).

In any case, it is assumed that the user of the posting support apparatus 10 takes a picture of a subject (e.g., a finished dish and cooking equipment used for the dish, etc. or a caught fish and a fishing tool used for catching the fish, etc.) according to the purpose of posting on a posting site as described above every day, in order to post it to the posting site.

Therefore, a large amount of image data is accumulated over time in a storage device of the posting support apparatus 10, and a more enormous image data group is formed as the user is more enthusiastic for the above-mentioned posting site or more eager to take pictures.

The posting support apparatus 10 according to the present embodiment may be a smartphone, a tablet terminal, a notebook PC, or the like provided with an appropriate communication function to a network NW. The network NW may be the Internet, a local area network (LAN), or a communication line for short-range wireless communication.

As an example of software held by the posting support apparatus 10, a mobile application that operates on a mobile terminal, i.e., an application 171 is assumed. This application 171 enables viewing of published posts and a posting operation by the user through a browsing function on the posting site published by the posting site system 20.

A person who operates such a posting support apparatus 10 accesses the posting site via the posting support apparatus 10. Then, the person views a desired post and uses it as a reference for his/her own activity. For example, if the posting site is a recipe posting site, the user of the posting support apparatus 10 refers to a recipe posted by another user, prepares ingredients necessary for cooking, and cooks by himself/herself.

In addition, such a user posts a photo image stored in a photo folder of the posting support apparatus 10 using a report function provided on the recipe posting site in order to report that a dish was prepared based on the referenced recipe or report whether the recipe was good or bad. Such a post must be accompanied by a photo of the finished dish, which is to be reflected on the page of the recipe with the permission of the recipe author.

However, the number of images stored in the photo folder is often enormous, and it has been difficult for the user to quickly identify an image that matches the purpose of use. The present embodiment solves such a problem, enables efficient search of images without any particular burden on the user, and enables effective utilization of the images.

On the other hand, the posting site system 20 is a server apparatus that manages the posts of each user published on the posting site operated by the posting site system 20.

The posting site system 20 of the present embodiment is assumed to be an apparatus that manages and operates a so-called recipe posting site. The posting site system 20 exemplified here is a web server that publishes the recipe posting site described above on the network NW such as the Internet.

In the posting site published by the posting site system 20, various persons, regardless of whether famous or unknown, make posts. Similarly, various persons access and view posts of their necessary genre or favorite poster.

The posting site system 20 in the present embodiment has a machine learning engine as a characteristic configuration, and executes machine learning using an image (e.g., a dish is the subject) included in each post and a description (e.g., the name or type of the dish) of the post as training data and generates a trained model using the feature in an image as an explanatory variable and the type of the subject in the image as a response variable.

The posting site system 20 is assumed to distribute the trained model generated as described above to the posting support apparatus 10 via the network NW, for example. This allows the posting support apparatus 10 to utilize this trained model to classify each image held in its own photo folder by the type of the subject.

Hereinafter, a specific configuration of the posting support apparatus 10 of the present embodiment and its processing procedure will be sequentially described.

<Configuration of Posting Support Apparatus>

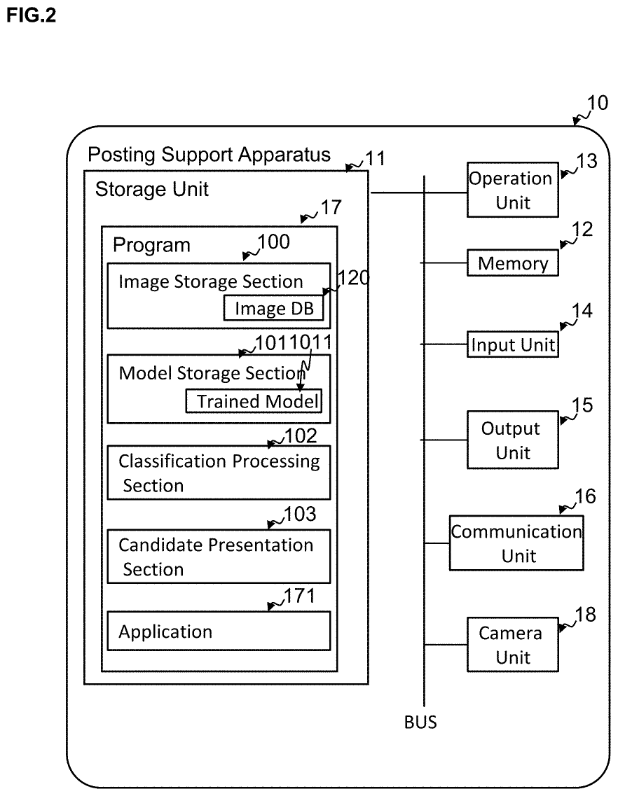

Next, an example configuration of the posting support apparatus 10 in the present embodiment will be described. FIG. 2 is a diagram showing an example configuration of the posting support apparatus 10 in the present embodiment. As shown in FIG. 2, the posting support apparatus 10 of the present embodiment includes a storage unit 11, a memory 12, an operation unit 13, an input unit 14, an output unit 15, a communication unit 16, and a camera unit 18.

Among these, the storage unit 11 is composed of a nonvolatile storage element such as a hard disk drive (HDD) or a solid state drive (SSD).

In the storage unit 11, at least the application 171 is stored as a program 17 for implementing functions necessary for the posting support apparatus of the present embodiment. As described above, this application 171 enables viewing and posting of a post (including posting of a report on the use of another person's post) via the browsing function on the posting site published by the posting site system 20.

The storage unit 11 is provided with a photo folder for storing images captured by a camera unit 18 of the posting support apparatus 10. This photo folder corresponds to an image storage section 100, and the image data group is referred to as an image DB 120.

Similarly, the storage unit 11 is provided with a model storage section 101 for storing a trained model 1011 distributed from the posting site system 20 in a model DB 121. Details of generation and distribution of the trained model 1011 will be described later.

Although not shown, it is assumed that the storage unit 11 stores membership information, which is identification information of the user who owns the posting support apparatus 10. This membership information is issued to a registered user in a membership service provided by the operator of the posting site system 20, and includes a membership number that uniquely identifies the user, a user attribute, and the like. The memory 12 is composed of a volatile storage element such as a RAM.

Further, assumed as the operation unit 13 is a CPU that reads the program 17 held in the storage unit 11 into the memory 12 and executes the program 17 to implement the functions necessary for the posting support apparatus. The functions implemented here include functions of a classification processing section 102 and a candidate presentation section 103 in addition to the functions of an information processing terminal such as a general smartphone.

The above-described classification processing section 102 is a function of reading each of a plurality of image data items from the image DB 120 in the image storage section 100 of the storage unit 11, inputting each image data item to the trained model 1011, and classifying each image data item as a target image in which a subject of a specified type (e.g., a dish) is captured or a non-target image in which a subject other than the subject of the specified type (e.g., a cooking utensil) is captured.

For example, classifying each image in the image DB 120 based on the classification of dish images or non-dish images to identify only dish images and displaying the dish images by a candidate presentation section 103 allows the user to easily select an image for posting and effectively reduces the user's burden relating to the posting work. This, in turn, encourages posting of photos to the posting site.

The candidate presentation section 103 is a function of displaying the target images or non-target images, which are the results of the classification by the classification processing section 102, on the output unit 15 as user's utilization candidate images. When displaying the target images or non-target images, the candidate presentation section 103 preferably generates a list of thumbnails of the target images or non-target images and causes the output unit 15 to display the list.

Furthermore, the candidate presentation section 103 may associate a plurality of non-target images with one thumbnail, and superimpose information indicating the number of (associated) non-target images (the value of the number of images itself, an icon representing the scale of the number of images, or the like) on the thumbnail.

For the user, non-target images, which are not likely to be posted, are aggregated into the form of a thumbnail, and are less likely to interfere with the operation of selecting a target image. In other words, the efficiency of image selection for posting is improved. In the meanwhile, even in a situation where the user dares to post a non-target image, the thumbnail into which the non-target images are aggregated is easy to find, and a desired image can be easily identified, selected, and posted by, for example, tapping the thumbnail to expand it.

In this case, when receiving a user's operation to select the thumbnail, the candidate presentation section 103 expands and displays thumbnails of the non-target images associated with the selected thumbnail on the output unit 15.

The input unit 14 is assumed to be a keyboard, a mouse, a keypad, a touch panel, a microphone, or the like for receiving a key input or a voice input from the user. The output unit 15 is assumed to be a display or the like for displaying processed data.

The communication unit 16 is assumed to be a network interface card (NIC) or the like which connects to the network NW and performs communication processing with other devices such as the posting site system 20.

The camera unit 18 is a digital camera unit generally provided in a smartphone or the like, and is assumed to be a unit for capturing an image of a subject with an optical system in response to receiving an instruction from the user of the posting support apparatus 10 and obtaining data of a photo image, that is, image data. The image data obtained here is stored in the image DB 120 in the image storage section 100 of the storage unit 11.

<Configuration of Posting Site System>

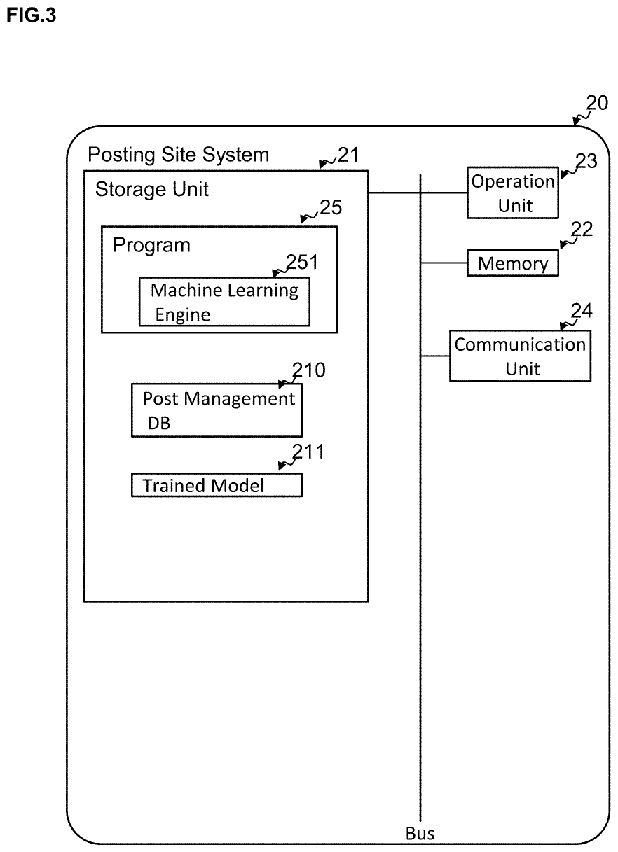

As shown in FIG. 3, the configuration of the posting site system 20 in the present embodiment includes a storage unit 21, a memory 22, an operation unit 23, and a communication unit 24.

Among these, the storage unit 21 is composed of a nonvolatile storage element such as a hard disk drive (HDD) or a solid state drive (SSD).

The storage unit 21 stores at least a post management DB 210 and a trained model 211 in addition to a program 25 for implementing the functions necessary for the posting site system of the present embodiment. Among these, the post management DB 210 is a database for managing the contents of posts posted by users, as is natural for the posting site system.

The trained model 211 is a model using the feature in an image as an explanatory variable and the type of the subject in the image as a response variable, and has a function of determining the type of the subject in an image when the image is given to the trained model 211. The memory 12 is composed of a volatile storage element such as a RAM.

Further, assumed as the operation unit 23 is a CPU that reads the program 25 held in the storage unit 21 into the memory 22 and executes the program 17 to implement the functions necessary for the posting site system. The functions implemented here include a function of generating the trained model 211 with the machine learning engine 251 in addition to the functions of a general posting site system.

The posting site system 20 in the present embodiment inputs an image (e.g., a dish is the subject) included in each post and a description (e.g., the name or type of the dish) of the post, which are held in the post management DB 210, to the machine learning engine 251 as training data to execute machine learning, and generates a trained model 211 using the feature in an image as an explanatory variable and the type of the subject in the image as a response variable.

The communication unit 24 is assumed to be a network interface card (NIC) or the like which connects to the network NW and performs communication processing with other devices such as the posting support apparatus 10.

<Specific Examples of Data>

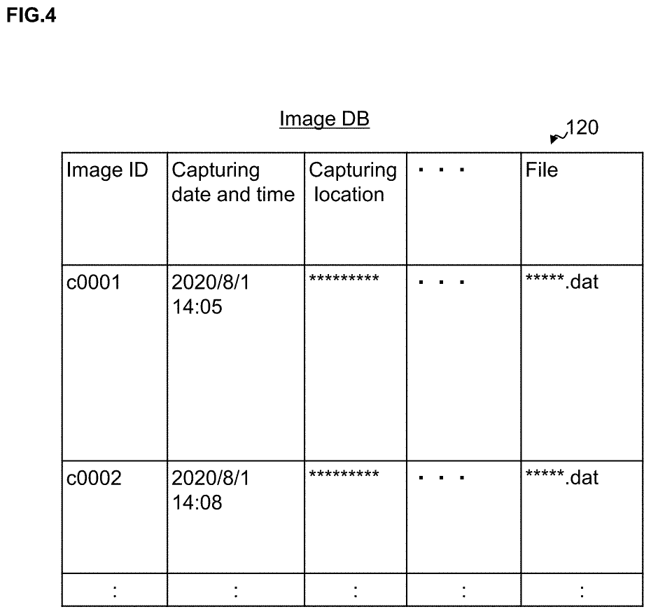

Next, various databases used by the posting support apparatus 10 of the present embodiment will be described. FIG. 4 shows an example data configuration of the image DB 120 in the present embodiment. The image DB 120 is a database that stores images captured by the camera unit 18.

However, not only images captured by the camera unit 18 but also images published on the network NW or images acquired from another user's terminal via the network NW or via short-range wireless communication can be stored.

The structure is, for example, a set of records in which an image ID uniquely indicating image data is stored as a key item and metadata such as a capturing date and time and a capturing location of the image data are associated with data such as a file name (which may be a storage address).

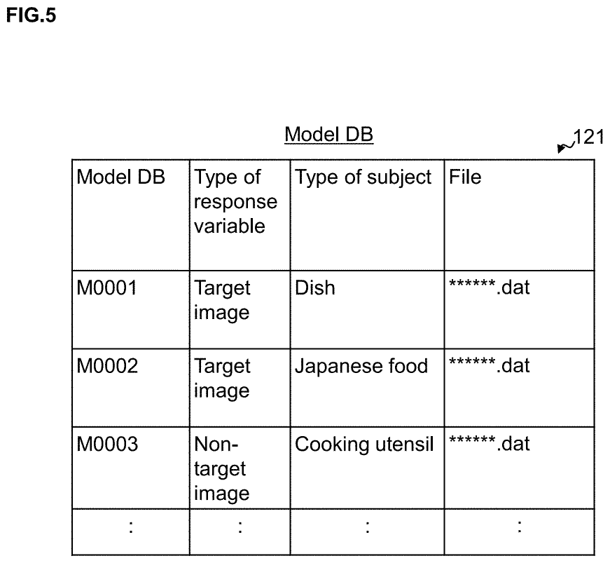

FIG. 5 shows an example data configuration of the model DB 121 in the present embodiment. The model DB 121 is a database storing the trained model 1011 distributed from the posting site system 20.

The structure is, for example, a set of records in which a model ID uniquely indicating a trained model is stored as a key item and data such as a type of a response variable (whether it relates to a target image or a non-target image), a type of a subject corresponding to the response variable, a file (or where it is stored) storing an entity of the trained model, and the like are associated with the trained model.

<Posting Support Method: Trained Model Generation/Acquisition Flow>

Next, an actual procedure of the posting support method in the present embodiment will be described with reference to drawings. Various operations corresponding to the posting support method to be described below are implemented by a program executed by the posting support apparatus 10 and the posting site system 20, for example. The program is composed of codes for performing various operations to be described below.

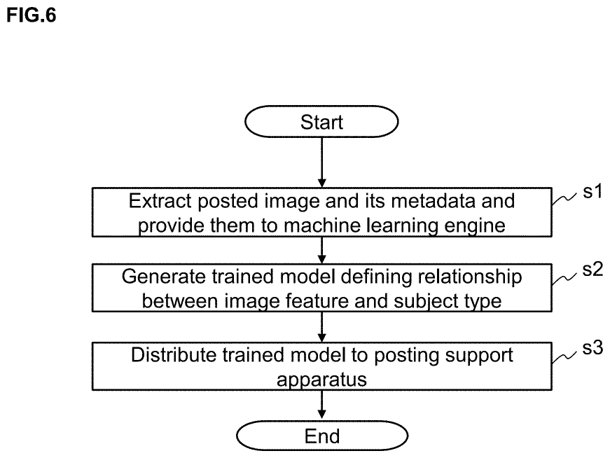

FIG. 6 is a diagram showing an example flow of the posting support method in the present embodiment. Here, a series of steps from generation of the trained model 211 in the posting site system 20 to acquisition and storage of the trained model 1011 in the posting support apparatus 10 will be described.

In this case, the posting site system 20 extracts a posted image and metadata relating to the posted image from the post data held in the post management DB 210, for example, at regular intervals, and provides these to the machine learning engine 251 as training data (s1).

In the process s1 described above, the information about the type of the subject indicated by the metadata about the posted image is the correct value in the machine learning. As the type of the subject, values such as a dish name and a dish genre to be posted on the recipe posting site can be assumed.

On the other hand, the posted image is processed by a feature extraction algorithm held in advance by the posting site system 20. In this feature extraction algorithm process, a feature is extracted from the posted image. The feature is not particularly limited, but various features such as a histogram of oriented gradients (HOG) and a scaled invariance feature transform (SIFT) may be employed as appropriate.

The posting site system 20 uses the machine learning engine 251 to proceed with machine learning using the type of the subject in each posted image as correct data (i.e., a response variable) and the feature of the posted image as an explanatory variable, and generates a trained model 211 defining the relationship between the image feature and the subject type (s2).

The posting site system 20 in the present embodiment is assumed to input a dish image (e.g., a dish is the subject) included in a posted recipe and a description (e.g., the name or type of the dish) of the posted recipe, which are held in the post management DB 210, to the machine learning engine 251 as training data to execute machine learning, and generate a trained model 211 using the feature in the dish image as an explanatory variable and the type of the subject in the dish image as a response variable.

Further, the posting site system 20 distributes the trained model 211 generated in s2 to the posting support apparatus 10 via the network NW (s3).

On the other hand, the posting support apparatus 10 stores the trained model 211 distributed from the posting site system 20 in the model DB 121 of the storage unit 11, and ends the processing. The processing up to this point allows the posting support apparatus 10 to acquire the trained model generated by using an enormous number of posts managed by the posting site as training data, and to be ready to perform classification of each image held in the image DB 120 of the posting support apparatus 10.

<Posting Support Method: Image Classification and Candidate Presentation Flow>

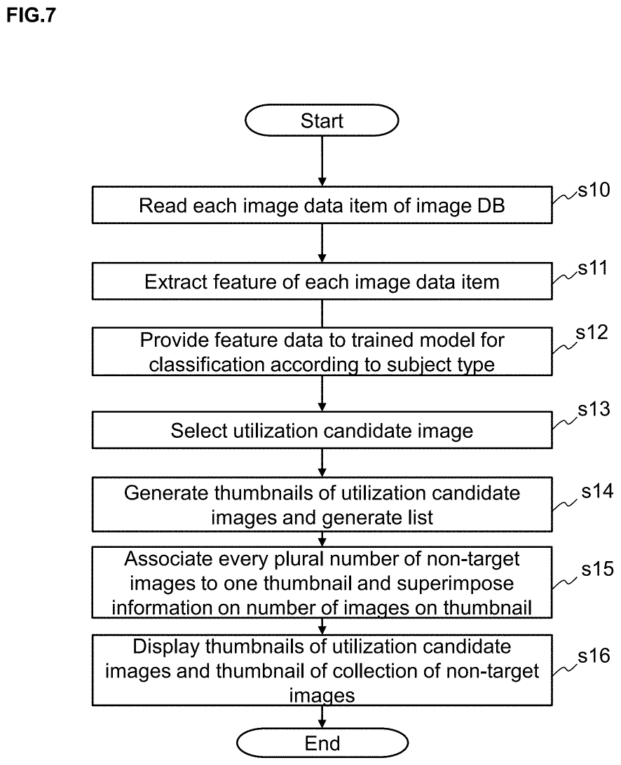

FIG. 7 is a diagram showing an example flow of the posting support method in the present embodiment. Here, the flow of processing by the classification processing section 102 and the candidate presentation section 103 will be described.

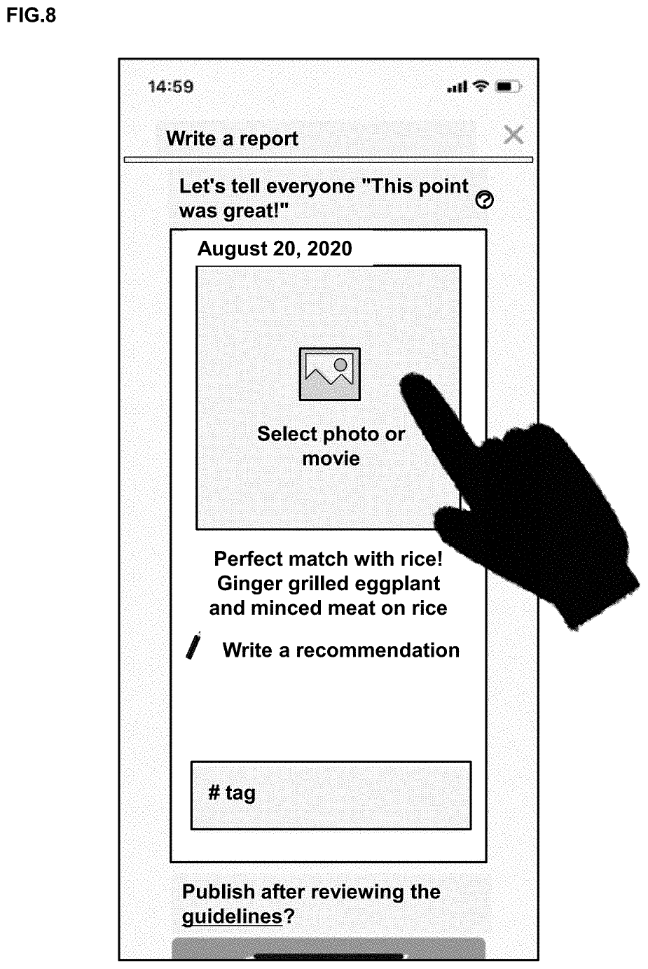

In this case, the classification processing section 102 of the posting support apparatus 10, for example, senses a user's posting operation in the application 171 (see FIG. 8; tap on the “select photo or video” icon) or receives a user's instruction at the input unit 14, and reads each of the image data items held in the image DB 120 of the image storage section 100 (s10).

The classification processing section 102 of the posting support apparatus 10 also provides each image data item read in s10 to the feature extraction algorithm held by the posting support apparatus 10, and extracts the feature of each image data item (s11).

Subsequently, the classification processing section 102 of the posting support apparatus 10 inputs data of the feature acquired for each image data item in s11 to the trained model 1011, and determines whether the subject type of each image data item is the target image (or non-target image) specified by the trained model 1011 (s12).

This process is a process of classifying each image data item of the image DB 120 as a target image in which a subject of a specified type (e.g., a dish) is captured or a non-target image in which a subject other than the subject of the specified type (e.g., a cooking utensil) is captured. For example, each image in the image DB 120 is classified to identify only dish images.

In the subject type determination using the trained model 1011 described above, image data that is not classified as either a target image or a non-target image may be classified as an “other” image, for example. In this case, display control may be performed such that the thumbnail of the image is displayed in a form different from either the target image or the non-target image (e.g., different color tone or thumbnail shape) or a text or icon indicating that the image is an “other” image is provided in a thumbnail list to be described later.

Subsequently, the candidate presentation section 103 of the posting support apparatus 10 selects the target images (or non-target images), which are the results of the processing by the classification processing section 102 in s12, as user's utilization candidate images (s13).

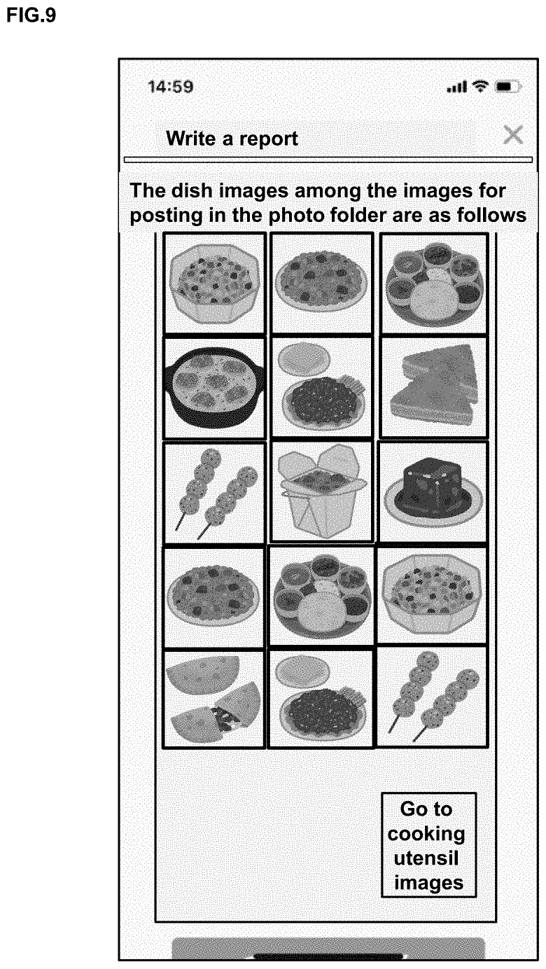

The candidate presentation section 103 of the posting support apparatus 10 also generates thumbnails of the utilization candidate images selected in s13 to generate a thumbnail list (see FIG. 9) (s14). At this time, it is preferable that the candidate presentation section 103 of the posting support apparatus 10 arranges the thumbnails at the initial positions in the photo folder (i.e., the capturing order of the images) to improve the efficiency of the user's image selection work. This is because it is natural for the user to check from the most recently captured new images and to gradually search back to the old images.

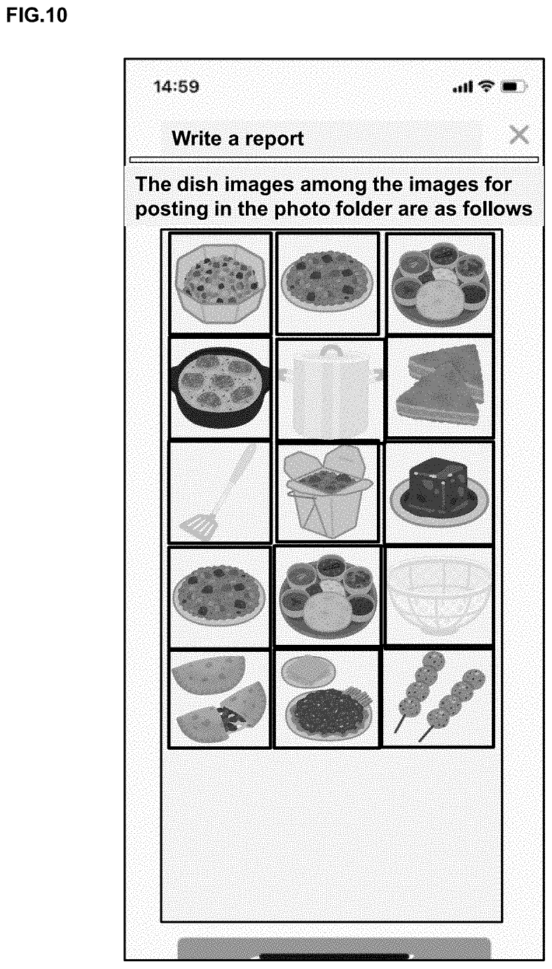

It is also preferable that the candidate presentation section 103 of the posting support apparatus 10 similarly generates thumbnails of images other than the above-mentioned utilization candidate images, i.e., non-target images such as cooking utensil images, grays out the thumbnails (see FIG. 10) for display control to deliberately exclude them from the user's search target temporarily.

It is preferable that the thumbnails of the non-target images are also arranged at the initial positions in the photo folder (i.e., the capturing order of the images) in the same manner as the utilization candidate images to improve the efficiency of the user's image selection work.

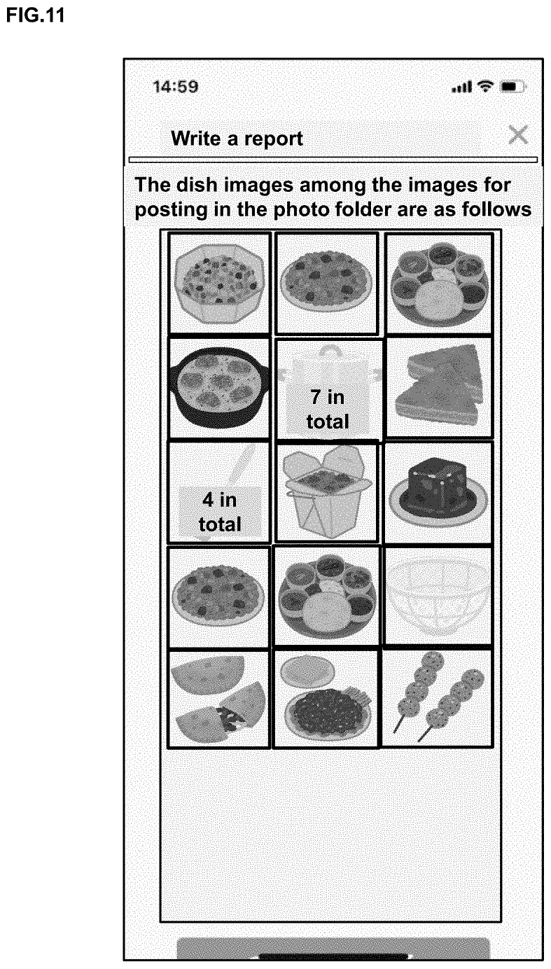

Further, the candidate presentation section 103 of the posting support apparatus 10 associates, for example, every predetermined plural number of images other than the above-mentioned utilization candidate images, i.e., non-target images, to one thumbnail, and superimposes information indicating the number of (associated) non-target images (the value of the number of images itself, an icon representing the scale of the number of images, or the like) on the thumbnail (see FIG. 11) (s15).

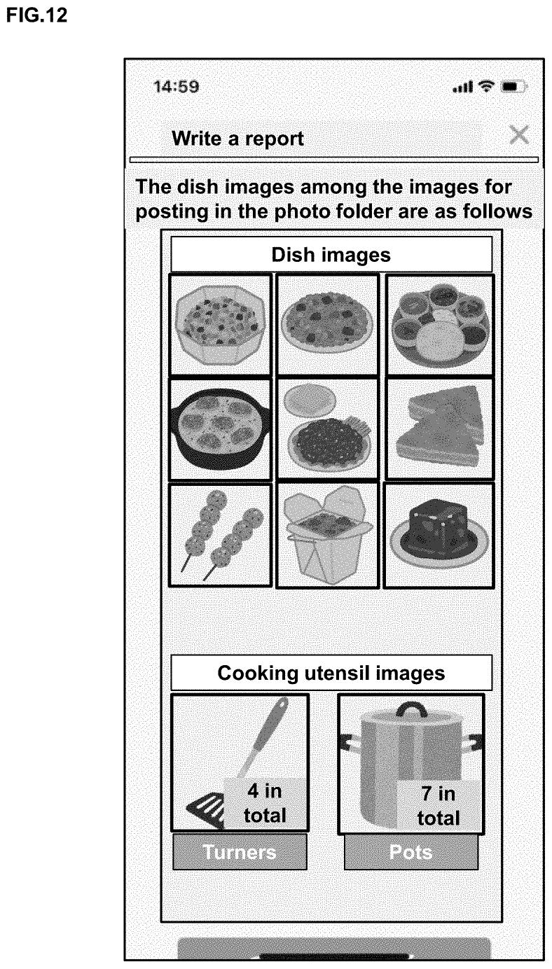

The candidate presentation section 103 of the posting support apparatus 10 displays the thumbnails of the utilization candidate images (target images) and one thumbnail representing a plurality of non-target images generated so far on the display of the output unit 15 as shown in the screen example of FIG. 11 (s16), and ends the processing. As exemplified in FIG. 12, the display positions may be divided by the type of the subject, such as a dish image and a cooking utensil image.

Such a display allows the user to select an image efficiently, using the utilization candidate images as the main selection target and checking the non-target images as necessary. This effectively reduces the user's burden related to the posting work. This, in turn, encourages posting of photos to the posting site.

In addition, for the user, non-target images, which are not likely to be posted, are aggregated in the form of a thumbnail, and are less likely to interfere with the operation of selecting a target image from the utilization candidate images. In other words, the efficiency of image selection for posting is improved.

In the meanwhile, even in a situation where the user dares to post a non-target image, the thumbnail into which the non-target images are aggregated is easy to find, and a desired image can be easily identified and selected from the thumbnails of the non-target images, and posted by, for example, tapping the thumbnail to expand it.

In this case, when receiving a user's operation to select the thumbnail, the candidate presentation section 103 expands and displays thumbnails of the non-target images associated with the selected thumbnail on the output unit 15.

While the best mode and the like for carrying out the present disclosure has been specifically described above, the present disclosure is not limited thereto, and various modifications can be made without departing from the gist thereof. According to the present embodiment, it is possible to efficiently search images held in an information terminal, and in turn effectively utilize the images.

The posting support method of the present embodiment may be achieved by recording a program for implementing each function constituting the posting support apparatus on a computer-readable recording medium, and causing a computer system to read the program recorded on the recording medium to give instructions to the computer system.

Specifically, the program is a computer-executable program for causing an information processing apparatus to hold a plurality of image data items and a trained model for determining a type of a subject in an image, and execute a process of inputting each of the image data items into the trained model to classify each of the image data items as a target image in which a subject of a specified type is captured or a non-target image in which a subject other than the subject of the specified type is captured and a process of displaying the target image or the non-target image as a user's utilization candidate image.

Here, the term “computer system” used here includes hardware such as an OS and peripheral devices. The term “computer-readable recording medium” refers to a portable medium such as a flexible disk, a magneto-optical disk, a ROM, a CD-ROM, a USB memory, or a storage device such as a hard disk or an SSD built into a computer system.

Further, the “computer-readable recording medium” may include a medium which dynamically holds a program for a short time, such as a communication line in the case of transmitting the program via a network such as the Internet or a communication line such as a telephone line, and a medium which holds the program for a fixed time, such as a volatile memory in a computer system serving as a server or a client in that case.

In addition, the above-mentioned program may be a program for implementing a part of the above-mentioned functions, or may be a program capable of implementing the above-mentioned functions in combination with a program already recorded in the computer system.

### EXPLANATION OF REFERENCE NUMERALS

10: posting support apparatus
11: storage unit
12: memory
13: operation unit
14: input unit
15: output unit
16: communication unit
17: program
171: application
18: camera unit
100: image storage section
101: model storage section
1011: trained model
102: classification processing section
103: candidate presentation section
120: image DB
121: model DB
20: posting site system
21: storage unit
210: post management DB
211: trained model
22: memory
23: operation unit
24: communication unit
25: program
251: machine learning engine

1. A posting support apparatus comprising:
a memory configured to store:
a plurality of image data items; and
a trained model for determining a type of a subject in an image, and
processing circuitry configured to:
input each of the image data items to the trained model to classify each of the image data items as a target image in which a subject of a specified type is captured or a non-target image in which a subject other than the subject of the specified type is captured; and
display the target image or the non-target image as a user's utilization candidate image.

2. The posting support apparatus according to claim 1, wherein the processing circuitry is further configured to generate a thumbnail list of the target image or the non-target image and output the thumbnail list.

3. The posting support apparatus according to claim 2, wherein the processing circuitry is further configured to associate a plurality of the non-target images to one thumbnail, superimpose information indicating a number of the non-target images on the thumbnail, and expand and display thumbnails of the non-target images associated with the thumbnail when receiving a user's operation to select the thumbnail.

4. A posting support method, wherein
an information processing apparatus
holds a plurality of image data items and a trained model for determining a type of a subject in an image; and
executes
a process of inputting each of the image data items to the trained model to classify each of the image data items as a target image in which a subject of a specified type is captured or a non-target image in which a subject other than the subject of the specified type is captured, and
a process of displaying the target image or the non-target image as a user's utilization candidate image.

5. The posting support method according to claim 4, wherein the information processing apparatus generates a thumbnail list of the target image or the non-target image and outputs the thumbnail list.

6. The posting support method according to claim 5, wherein the information processing apparatus associates a plurality of the non-target images to one thumbnail, superimposes information indicating a number of the non-target images on the thumbnail, and expands and displays thumbnails of the non-target images associated with the thumbnail when receiving a user's operation to select the thumbnail.

7. A non-transitory computer-readable recording medium that stores a program, wherein the computer hold a plurality of image data items and a trained model for determining a type of a subject in an image; and
the program causes a computer to execute a method comprising:
inputting each of the image data items to the trained model to classify each of the image data items as a target image in which a subject of a specified type is captured or a non-target image in which a subject other than the subject of the specified type is captured, and
displaying the target image or the non-target image as a user's utilization candidate image.
